(19) United States
(12) Patent Application Publication
(10) Pub. No.: US 2026/0085205 A1
(43) Pub. Date: Mar. 26, 2026

(54) PRIMER COMPOSITIONS CONTAINING AN OPTICAL BRIGHTENER AND INKJET PRINTING METHODS ASSOCIATED THEREWITH

(71) Applicant: XEROX CORPORATION, Norwalk, CT (US)

(72) Inventors: Varun SAMBHY, Pittsford, NY (US); Eliud ROBLES-FLORES, Rochester, NY (US); Guo-Yau LIN, The Woodlands, NY (US); Carlos F. GOMEZ, Sierra Madre, CA (US); Steven M. RUSSEL, Bloomfield, NY (US)

(73) Assignee: XEROX CORPORATION, Norwalk, CT (US)

(21) Appl. No.: 18/894,922

(22) Filed: Sep. 24, 2024

(51) Int. Cl. C09D 11/54; B41J 2/21; B41J 3/407; B41J 11/00; C09D 11/30

(52) U.S. Cl. CPC C09D 11/54; B41J 2/2117; B41J 3/407; B41J 11/0015; C09D 11/30

(57) ABSTRACT

Primer compositions containing an optical brightener may be utilized to increase the vibrancy of ink images that are subsequently deposited upon a print substrate. Such primer compositions may comprise an aqueous fluid, a metal salt dissolved in the aqueous fluid, and an optical brightener dissolved in the aqueous fluid. The primer compositions may be deposited upon at least a portion of a print substrate, and the aqueous fluid may be evaporated to form a primer coating upon the print substrate. An ink may then be deposited in an imagewise pattern upon at least a portion of the primer coating.

### FIELD

The present disclosure generally relates to inkjet printing and, more specifically, to primer compositions suitable for use in conjunction with inkjet printing.

### BACKGROUND

Inkjet printers eject liquid ink from a print head onto a print substrate to form an image. Common inkjet print heads include a stack of plates, referred to as a jet stack, with an outermost plate having an array of nozzles for ink dispensation. Based on a digital image, a driver moves the print head relative to the print substrate to facilitate ink deposition in a desired location to reproduce the digital image in an imagewise pattern on the print substrate. Each nozzle may include a thermal or piezoelectric actuator to promote dispensation of ink droplets onto the print substrate in a desired location. Digital acoustic inkjet printing is also becoming more common. The print substrate is usually a continuous web of media material or a series of media sheets.

Inkjet printers used for producing color images typically include multiple print head modules, each containing one or more print heads. Each print head within a print head module typically ejects a single color of ink. In typical color inkjet printers, four print head modules are commonly used to deposit cyan, magenta, yellow, and black inks. The common nomenclature for such inkjet printers is CMYK color printers.

The image quality obtained during inkjet printing may vary depending on the type of print substrate being utilized. Image quality is typically excellent when printing takes place on offset coated, non-glossy media because the ink remains on top of the coating. Uncoated, porous media, in contrast, may afford dull images due to ink absorption into the print substrate. This issue may be especially problematic for print substrates that are non-white in color.

To avoid the foregoing issue with image appearance, primer compositions may be applied to porous print substrates to form a primer coating thereon, which may reduce the amount of ink absorption taking place during inkjet printing. Primer coatings additionally may reduce the interaction between the ink and the print substrate, since the primer coating is interposed between the print substrate and a printed image. Because the printed image is deposited upon the primer coating instead of directly upon the print substrate, the printed image may be more easily removable from the print substrate in a de-inking process, such as to facilitate recycling efforts.

Primer compositions may include metal salts dissolved in an aqueous medium. When deposited within a primer coating, the metal salt may promote rapid precipitation of pigment and other ink components (e.g., ink latex particles) upon the primer coating rather than absorbing into the print substrate. By keeping the pigment on the primer coating, rather than absorbing into the print substrate, gamut and intensity of the printed image may increase, thereby improving the appearance of the image. Additionally, the primer coating may decrease movement and spreading of ink droplets, thereby improving graininess and inter-color bleeding.

Primer coatings may be deposited upon a print substrate prior to an inkjet printing process (e.g., by stockpiling a supply of primer-coated print substrate) or during an inkjet printing process by depositing a primer composition to form the primer coating upon a print substrate in situ. For in situ formation of a primer coating, two methods are commonly used. In one technique, a roller may be brought into contact with the print substrate to apply the primer composition non-specifically to the entirety of the print substrate. In another technique, the primer composition may be deposited upon selected areas of the print substrate (or non-selectively if desired) by an in situ application process similar to that by which the ink is deposited (e.g., by inkjet printing).

Although conventional primer coatings may improve the appearance of images resulting from printing on otherwise uncoated print substrates, they do not universally resolve the image appearance issue. Even when conventional primer coatings are used, dull images may continue to be problematic for print substrates having non-white backgrounds such as cardboard stock, brown paper, kraft paper/packaging, and vinyl or other plastic stocks, just to name a few. Therefore, primer compositions facilitating printing of high-quality images upon a more diverse range of print substrates continue to be desirable.

### SUMMARY

In some embodiments, the present disclosure provides primer compositions comprising: an aqueous fluid; a metal salt dissolved in the aqueous fluid; and an optical brightener dissolved in the aqueous fluid.

In some or other embodiments, the present disclosure provides printing methods comprising: depositing a primer composition of the present disclosure upon a print substrate; evaporating the aqueous fluid to form a primer coating upon at least a portion of the print substrate, the primer coating comprising the metal salt and the optical brightener; and depositing an ink in an imagewise pattern upon at least a portion of the primer coating.

### BRIEF DESCRIPTION OF THE DRAWINGS

Not applicable.

### DETAILED DESCRIPTION

The present disclosure generally relates to inkjet printing and, more specifically, to primer compositions suitable for use in conjunction with inkjet printing.

As discussed above, inkjet printing may be utilized to deposit ink in an imagewise pattern upon a variety of print substrates, although some print substrates may produce images having better quality or visual appearance than do others. Forming a primer coating upon a print substrate may alleviate this issue for some types of print substrates. However, even when conventional primer coatings are applied, print substrates having a non-white background may continue to be problematic.

The present disclosure provides primer compositions and primer coatings formed therefrom that may alleviate the foregoing concerns and provide related advantages as well. In particular, the present disclosure provides primer compositions also containing an optical brightener that may improve the visual appearance of a printed image upon a print substrate. The optical brightener may increase the vibrancy of the printed image, especially upon print substrates that may otherwise lead to a sub-optimal image appearance. Surprisingly, an optical brightener may be readily formulated with a metal salt in a primer composition without the metal salt causing issues in formulating the primer composition or degrading performance of the optical brightener following ink deposition upon the resulting primer coating.

In the present disclosure, the term “optical brightener” is used to refer equivalently to whiteners, optical brighteners, optical brightening agents (OBAs), fluorescent brightening agents (FBAs), fluorescent whitening agents (FWAs), and like fluorescent substances, examples of which are provided hereinbelow. Optical brighteners are chemical compounds that absorb light in the ultraviolet and violet region (usually 340-370 nm) of the electromagnetic spectrum, and re-emit the absorbed electromagnetic radiation in the blue region (typically 420-470 nm) of the electromagnetic spectrum through a fluorescence process. The emitted blue light results in whitening and brightening of the image appearance in locations where the optical brightener is present, especially on problematic print substrates that may otherwise lead to a dull image appearance. Without being bound by any theory or mechanism, the increase in brightness is believed to result from more net visible light being viewable by an observer, since incident ultraviolet light (invisible to the human eye) is converted to visible light by the optical brightener. Additionally, the emitted blue light may enhance the blueness of an image where it is desirable to do so. For example, in the case of intrinsically yellow/orange materials, emitted blue and purple light from the optical brightener may compensate for the deficit of blue and purple that would otherwise be present in the printed image. Thus, the optical brightener may decrease the yellow/orange appearance of the printed image and increase the blue/purple appearance of the printed image.

Optical brighteners are well known substances and are widely used in the paper, laundry detergent, and cosmetic industries, for example. Preferred optical brighteners are non-toxic and many are inexpensive. As such, optical brighteners may be readily incorporated in primer compositions according to the present disclosure to provide additional versatility, value, and functionality to primer coating technology but without adding significant costs or other complications to an inkjet printing process in which the primer compositions are used.

Using an optical brightener in a primer composition may be more advantageous than using the optical brightener in an ink composition to achieve a technical effect of image enhancement. Ink compositions may contain a number of components that may increase the risk of undesired chemical or electronic interactions with the optical brightener. Optical brighteners may also change the ink color in some cases. Primer compositions, in contrast, usually have a much simpler chemical makeup and therefore present a lower risk of undesired interactions with the optical brightener. Moreover, by depositing the optical brightener separately from the ink, greater printing versatility may be realized, including avoiding the need to formulate custom ink blends containing the optical brightener.

Accordingly, primer compositions of the present disclosure may comprise: an aqueous fluid, a metal salt dissolved in the aqueous fluid, and an optical brightener dissolved in the aqueous fluid.

Primer compositions incorporating suitable metal salts may have a number of advantages, including low material costs for the metal salt and the ability to improve print quality on both coated and uncoated paper or other print substrates. The mechanism by which suitable metal salts promote desolubilization or precipitation of one or more components of an ink to preclude absorption into a porous print substrate is not believed to be particularly limited. In non-limiting examples that are not limited by theory, desolubilization of pigment particles or other components of an inkjet ink may be accomplished by proton transfer resulting from collision or close proximity of a cation of the metal salt and pigment particles or other components of the inkjet ink.

The primer compositions disclosed herein may comprise water or a mixture of water and one or more organic solvents (i.e., one or more water-miscible organic solvents that are dissolved in the aqueous fluid). When used, the one or more organic solvents may be present in an amount up to about 50 wt %, based on total mass of the primer composition. In further non-limiting examples, the one or more organic solvents may be present at about 1 wt % to about 10 wt %, or about 10 wt % to about 15 wt %, or about 15 wt % to about 30 wt %, based on total mass of the primer composition.

Examples of suitable water-miscible organic solvents that may be present in the primer compositions disclosed herein include, but are not limited to, a diol, a glycol, a glycol ether, glycerol or other polyols, or any combination thereof. Particular examples of suitable organic solvents may include, for instance, ethylene glycol, propylene glycol, 1,3-propanediol, 1,2-butanediol, 1,3-butanediol, 1,4-butanediol, 1,2-pentanediol, 1,5-pentanediol, 1,2-hexanediol, 1,6-hexanediol, 3-methoxy-1-butanol, diethyleneglycol monomethyl ether, glycerol, and the like. Other examples of suitable organic solvents that may be present in the primer compositions disclosed herein include, but are not limited to, diethylene glycols and monoalkyl ethers thereof, dipropylene glycols and monoalkyl ethers thereof, polyethylene glycols, polypropylene glycols, trimethylolpropane, 2-methyl-1,3,-propanediol, 2-ethyl-2-hydroxymethyl-1,3-propanediol, 3-methyl-1,5-pentanediol, 2,4-heptanediol, sulfolane, carbitol, butyl carbitol, 2-ethoxyethanol (ETHYL CELLOSOLVE), 2-butoxyethanol (BUTYL CELLOSOLVE), tripropylene glycol monomethyl ether, ethers, ether derivatives, hydroxyethers, amino alcohols, ketones, N-methylpyrrolidinone, 2-pyrrolidinone, cyclohexylpyrrolidone, substituted and unsubstituted formamides, substituted and unsubstituted acetamides, the like, or any combination thereof. Any of the foregoing may be utilized alone or in combination with ethylene glycol, propylene glycol, 1,3-propanediol, 1,2-butanediol, 1,3-butanediol, 1,4-butanediol, 1,2-pentanediol, 1,5-pentanediol, 1,2-hexanediol, 1,6-hexanediol, 3-methoxy-1-butanol, diethyleneglycol monomethyl ether, glycerol and the like as well.

When present, the organic solvent(s) may lower the surface tension of the primer compositions. In addition to organic solvents, one or more surfactants may be present in the primer compositions to lower the surface tension.

In non-limiting examples, the primer compositions disclosed herein may have a surface tension that is lower than that of a subsequently deposited ink. For example, the primer composition may have a surface tension that is about 0.1 mN or less than that of the ink, or about 0.5 mN or less than that of the ink, or about 1 mN or less than that of the ink. Illustrative surface tension ranges may include, for example, about 0.1 mN to about 0.3 mN less than that of the ink, or about 0.4 mN to about 0.7 mN less than that of the ink, or about 0.9 mN to about 1.3 mN less than that of the ink, or about 0.5 mN to about 1 mN less than that of the ink.

The metal salt may comprise an alkali metal salt, an alkaline earth metal salt, a main group metal salt, or any combination thereof. When a primer composition is used in conjunction with inkjet printing, the metal cation of the metal salt may facilitate desolubilization of pigment and other inkjet ink components to preclude absorption thereof into the print substrate. Depending on the periodic group from which the metal cation of the metal salt is chosen, the metal cation may be divalent or trivalent. In non-limiting examples, the metal salt may include metal cations such as, for example, Ca²⁺, Mg²⁺, Ba²⁺, B³⁺, Al³⁺ or any combination thereof. For purposes of this disclosure, boron (B) is considered to be a metal.

Any water-soluble metal salt containing the foregoing metal cations may be utilized in the primer compositions disclosed herein. The metal salts may include an anion that promotes solubility in water or an aqueous fluid. Examples of suitable metal salts having solubility in water or an aqueous fluid may include, for example, nitrates, halides, acetates, and the like. More particular examples of metal salts that may be suitably used in the primer compositions disclosed herein include, for example, magnesium chloride, magnesium nitrate, calcium chloride, calcium nitrate, barium chloride, barium nitrate, or any combination thereof.

The amount of metal salt included in the primer compositions disclosed herein may vary over a wide range. In non-limiting examples, the primer compositions may include the metal salt in an amount ranging from about 1 wt % to about 50 wt %, or about 5 wt % to about 40 wt %, or about 10 wt % to about 20 wt %, based on total mass of the primer composition. The foregoing wt% values are based on the total mass of the metal salt. An amount of metal cation in the primer compositions that originates from the metal salt may range from about 0.5 wt % to about 10 wt %, or about 1 wt % to about 10 wt %, or about 2 wt % to about 8 wt % of the primer composition, or about 1.5 wt % to about 5 wt %, again based on total mass of the primer composition.

Suitable optical brighteners are not believed to be particularly limited, provided that the optical brightener may be suitably dissolved in the aqueous fluid and the fluorescence effect of the optical brightener is not quenched by the metal salt present in the primer composition. Many optical brighteners are based upon a stilbene structure, although other types of chemical structures exhibiting optical brightening effects are known. Non-limiting examples of suitable optical brighteners may include, but are not limited to, TINOPAL™ grades such as TINOPAL™ SFD (BASF), UVITEX™ grades such as UVITEX™ NFW and UVITEX™ OB (Huntsman), LEUKOPHOR™ grades (Clariant), and BLANCOPHOR™ grades such as BLANCOPHOR™ REU and BLANCOPHOR™ BSU (Bayer).

The optical brightener may be included in the primer compositions in an effective amount to improve the appearance of a printed image. In non-limiting examples, an amount of the optical brightener in the primer compositions disclosed herein may range from about 0.01 wt % to about 5 wt %, or about 0.1 wt % to about 5 wt %, or about 0.05 wt % to about 3 wt %, or about 0.5 wt % to about 2 wt %, or about 2 wt % to about 5 wt %, based on total mass of the primer composition.

The primer compositions of the present disclosure may be utilized in conjunction with inkjet printing methods. Such methods may comprise: depositing a primer composition of the present disclosure upon a print substrate; evaporating the aqueous fluid to form a primer coating upon at least a portion of the print substrate, in which the primer coating comprises the metal salt and the optical brightener; and depositing an ink in an imagewise pattern upon at least a portion of the primer coating. As such, the primer coating, where present, may intervene between the print substrate and a printed image thereupon. It is to be appreciated that the methods described herein may also be applicable to other types of printing processes not employing inkjet deposition techniques.

The primer coating may cover all or a portion of the print substrate depending on application-specific considerations, including whether all or a portion of the printed image needs to be visually enhanced and/or the chosen technique used for depositing the primer composition to form the primer coating.

In some embodiments, the primer coating may cover an entirety of the print substrate. When the primer coating covers an entirety of the print substrate, the primer coating may be applied to the print substrate by techniques such as, for example, roller coating, spraying, immersion, or any combination thereof. Other deposition techniques capable of non-selectively depositing the primer composition upon the print substrate may also be suitably used.

When the primer composition is applied to the print substrate by roller coating, the primer composition may be applied by, for example, a foam roller or an anilox roller system in conjunction with a primer composition pump to apply the primer composition upstream from a set of print heads depositing ink upon the print substrate in an imagewise pattern. Other examples may include those in which the primer composition is applied using a gravure roller or a fuser roller, for instance. In another example, the entirety of the print substrate may be spray coated with the primer composition (e.g., with dedicated print heads or a similar nebulizer device) upstream from the print head(s) depositing ink upon the print substrate in an imagewise pattern. If desired, the spray coating process may be conducted with a similar mechanism to that used for jetting the ink, or a different process may be used.

When the primer composition is applied to the entirety of the print substrate, the primer composition may be applied to the print substrate in a manner to form a primer coating having a substantially uniform coating weight, which may be determined based upon the amount of primer composition applied to the print substrate. In non-limiting examples, the amount of primer composition applied to the print substrate may range from about 0.01 μL/cm² to about 2 μL/cm², or about 0.02 μL/cm² to about 1 μL/cm², or about 0.02 μL/cm² to about 0.5 μL/cm², or about 0.02 μL/cm² to about 0.2 μL/cm².

When the primer coating is applied to the entirety of the print substrate in the foregoing manner, the primer coating may be applied to the print substrate prior to supplying the print substrate to a printing process. The resulting primer-coated print substrate may be stockpiled for a subsequent printing process, if desired.

Alternately, the primer composition and the ink may be deposited upon the print substrate as part of an integrated printing process, in which the primer composition is deposited before the ink by jetting or spraying the primer composition from a first print nozzle or nebulizer, and the ink is then deposited upon the resulting primer coating by jetting from a second print nozzle. No stockpiling of primer-coated print substrate takes place during an integrated printing process. Spraying is to be understood as different from jetting in that spraying occurs more non-specifically and at lower pressure than does jetting. The foregoing integrated approach may afford considerably more process flexibility, as all or a portion of the print substrate may have a primer coating applied thereto by this process. For instance, in some examples, the primer composition may be deposited only in locations upon the print substrate that subsequently receive ink (i.e., selectively in locations where ink is to be deposited in an imagewise pattern). In some or other examples, the primer coating may not be present under a portion of the imagewise pattern, thereby differentially enhancing part of the imagewise pattern in comparison to others. In still other examples, the primer coating may be deposited in a watermarking pattern that may be utilized for various security measures, wherein the watermarking pattern may become apparent upon exposure to ultraviolet light.

In addition to selective deposition in the manner just described, when deposited in conjunction with a printing process, the primer coating may have the same coating weight or different coating weights at various locations upon the print substrate. Such uniform or non-uniform coating weights may reside within the ranges disclosed above. Locations where no primer coating is deposited may have a coating weight of zero. In addition, the primer coating may have varying coating weights under different portions of the imagewise pattern. Specifically, the primer coating may have a first coating weight under a first portion of the imagewise pattern and a second coating weight under a second portion of the imagewise pattern, in which the first coating weight differs from the second coating weight. Varying coating weights under different portions of the imagewise pattern (including zero coating weight where no primer coating is located under a portion of the image) may be utilized to differentially enhance various portions of the image in comparison to others, for example.

In some or other various examples, more or less primer composition may be applied to the print substrate under specific colors of ink to achieve a desired color gamut or similar image quality factor. For example, if one desires blues and blacks to have cooler (bluer) hues, then more primer composition may be deposited under locations having those colors (or a portion of the locations having those colors). Similarly, if one desires browns and yellows to have less blueish hues, then comparatively less primer composition may be deposited under locations having those colors. The coating weights of the deposited primer composition may be further optimized to achieve the most desired color gamut and image vibrancy for a specified application.

Suitable print substrates usable herein are not believed to be particularly limited. In some examples, the print substrate may be otherwise uncoated before applying the primer composition thereto. In some or other examples, the print substrate may be non-white in color. Illustrative materials for the print substrate may include, but are not limited to, cardboard, brown paper, kraft paper, plastic, vinyl, and any combination thereof. For example, a print substrate of brown cardboard may be a desirable medium for packing or crafts, where the primer coating may serve to enhance vibrancy in an otherwise brown, dull, or muted background. The resulting images may have improved image quality metrics such as gamut, graininess, and de-inkability on different types of print substrates.

Embodiments disclosed herein include the following:

A. Primer compositions. The primer compositions comprise: an aqueous fluid; a metal salt dissolved in the aqueous fluid; and an optical brightener dissolved in the aqueous fluid.

B. Printing methods. The methods comprise: depositing the primer composition of A upon a print substrate; evaporating the aqueous fluid to form a primer coating upon at least a portion of the print substrate, the primer coating comprising the metal salt and the optical brightener; and depositing an ink in an imagewise pattern upon at least a portion of the primer coating.

Each of embodiments A and B may include one or more of the following elements in any combination.

Element 1: wherein the metal salt comprises an alkali metal salt, an alkaline earth metal salt, a main group metal salt, or any combination thereof.

Element 2: wherein the metal salt comprises calcium nitrate, calcium chloride, magnesium nitrate, magnesium chloride, or any combination thereof.

Element 3: wherein the primer composition further comprises one or more organic solvents dissolved in the aqueous fluid.

Element 4: wherein the one or more organic solvents comprise a diol, a glycol, a glycol ether, glycerol, or any combination thereof.

Element 5: wherein the metal salt comprises a metal cation and an anion, and a concentration of the metal cation in the aqueous fluid ranges from about 1 wt % to about 10 wt %, based on total mass of the primer composition.

Element 6: wherein the primer coating covers an entirety of the print substrate

Element 7: wherein the primer composition is applied to the print substrate by roller coating, spraying, immersion, or any combination thereof.

Element 8: wherein the primer coating has a substantially uniform coating weight upon the print substrate.

Element 9: wherein the primer composition is applied to the print substrate prior to supplying the print substrate to a printing process.

Element 10: wherein the primer composition and the ink are deposited upon the print substrate in an integrated printing process, the primer composition being deposited upon the print substrate before the ink by jetting from a first print nozzle or nebulizer, and the ink being deposited upon the primer coating by jetting from a second print nozzle.

Element 11: wherein the primer composition is deposited upon only a portion of the print substrate.

Element 12: wherein the primer composition is deposited upon the print substrate only where ink is deposited in the imagewise pattern.

Element 13: wherein the primer coating has a first coating weight under a first portion of the imagewise pattern and a second coating weight under a second portion of the imagewise pattern, the first coating weight differing from the second coating weight.

Element 14: wherein the primer coating is not present under a portion of the imagewise pattern.

Element 15: wherein the print substrate is uncoated prior to depositing the primer composition.

Element 16: wherein the print substrate comprises a material selected from the group consisting of cardboard, brown paper, kraft paper, plastic, vinyl, and any combination thereof.

By way of non-limiting example, illustrative combinations applicable to A and B include, but are not limited to, 1 or 2, and 3; 1 or 2, 3 and 4; 1 or 2, 3 and 5; 1 or 2, and 5; 1 or 2, and 3-5; and 3-5. Illustrative combinations applicable to B may include any one or more of 1-6 or any of the foregoing combinations in further combination with one or more of 6-16, including the further combinations specified hereinafter. More specific examples of illustrative combinations applicable to B include, but are not limited to, 6 and 7; 6 and 8; 6 and 9; 6-8; 6-9; 6 and 7; 7 and 8; 7 and 9; 7-9; 8 and 9; 10 or 11, and 12; 10 or 11, and 13; 10 or 11, and 14; 12 and 13; and 12 and 14, any of which may be in further combination with 15 and/or 16.

To facilitate a better understanding of the present disclosure, the following examples of preferred or representative embodiments are given. In no way should the following examples be read to limit, or to define, the scope of the invention.

### EXAMPLES

Comparative Example 1. A comparative illustrative primer composition lacking optical brightener was formulated by combining 21.3 g glycerol, 193.1 propylene glycol, 497.5 g water, 293 g Mg(NO₃)₂•6H₂O, and 11.7 g non-ionic surfactant (DYNOL 607, Evonik) until a homogenous solution formed. The Mg²⁺content of the primer composition was 2.7 wt % based on total weight of the primer composition.

Example 1. An illustrative primer composition containing optical brightener was formulated by combining 21.3 g glycerol, 193.1 propylene glycol, 497.5 g water, 293 g Mg(NO₃)₂•6H₂O, 11.7 g non-ionic surfactant (DYNOL 607, Evonik), and 5 g TINOPAL NFW 10 optical brightener (10 wt % solution of 4,4′-bis(2-sulfostyryl)-biphenyl disodium salt, BASF) until a homogenous solution formed. The Mg²⁺ content of the primer composition was 2.7 wt %, based on total weight of the primer composition. The amount of active optical brightener in the primer composition was 0.05 wt %, based on total weight of the primer composition.

Example 2. An illustrative primer composition containing optical brightener was formulated by combining 21.3 g glycerol, 193.1 propylene glycol, 497.5 g water, 50 g CaCl₂, 11.7 g non-ionic surfactant (DYNOL 607, Evonik), and 5 g TINOPAL NFW 10 optical brightener (10 wt % solution of 4,4′-bis(2-sulfostyryl)-biphenyl disodium salt, BASF) until a homogenous solution formed. The Ca²⁺ content of the primer composition was 2.3 wt % based on total weight of the primer composition. The amount of active optical brightener in the primer composition was 0.06 wt %, based on total weight of the primer composition.

Printing Example. The primer compositions of Comparative Example 1 and Example 1 were applied to a corrugated media page using a foam pad brush. After drying, the coating print substrate was inkjet printed using a Xerox Baltoro press to generate an image upon the primer coating. Portions of the printed image overlaying either type of primer coating had a more vivid appearance and greater color density than did portions of the printed image printed on an uncoated location of the print substrate. Portions of the printed image overlaying the primer coating containing the optical brightener had visually enhanced blue color compared to those printed upon the comparative primer coating.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including. ” Whenever a method, composition, element, or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A primer composition comprising:
an aqueous fluid;
a metal salt dissolved in the aqueous fluid; and
an optical brightener dissolved in the aqueous fluid.

2. The primer composition of claim 1, wherein the metal salt comprises an alkali metal salt, an alkaline earth metal salt, a main group metal salt, or any combination thereof.

3. The primer composition of claim 1, wherein the metal salt comprises calcium nitrate, calcium chloride, magnesium nitrate, magnesium chloride, or any combination thereof.

4. The primer composition of claim 1, further comprising:
one or more organic solvents dissolved in the aqueous fluid.

5. The primer composition of claim 4, wherein the one or more organic solvents comprise a diol, a glycol, a glycol ether, glycerol, or any combination thereof.

6. The primer composition of claim 1, wherein the metal salt comprises a metal cation and an anion, and a concentration of the metal cation in the aqueous fluid ranges from about 1 wt % to about 10 wt %, based on total mass of the primer composition.

7. A method comprising:
depositing the primer composition of claim 1 upon a print substrate;
evaporating the aqueous fluid to form a primer coating upon at least a portion of the print substrate, the primer coating comprising the metal salt and the optical brightener; and
depositing an ink in an imagewise pattern upon at least a portion of the primer coating.

8. The method of claim 7, wherein the primer coating covers an entirety of the print substrate.

9. The method of claim 8, wherein the primer composition is applied to the print substrate by roller coating, spraying, immersion, or any combination thereof.

10. The method of claim 8, wherein the primer coating has a substantially uniform coating weight upon the print substrate.

11. The method of claim 8, wherein the primer composition is applied to the print substrate prior to supplying the print substrate to a printing process.

12. The method of claim 7, wherein the primer composition and the ink are deposited upon the print substrate in an integrated printing process, the primer composition being deposited upon the print substrate before the ink by jetting from a first print nozzle or nebulizer and the ink being deposited upon the primer coating by jetting from a second print nozzle.

13. The method of claim 12, wherein the primer composition is deposited upon only a portion of the print substrate.

14. The method of claim 13, wherein the primer composition is deposited upon the print substrate only where ink is deposited in the imagewise pattern.

15. The method of claim 14, wherein the primer coating has a first coating weight under a first portion of the imagewise pattern and a second coating weight under a second portion of the imagewise pattern, the first coating weight differing from the second coating weight.

16. The method of claim 13, wherein the primer coating has a first coating weight under a first portion of the imagewise pattern and a second coating weight under a second portion of the imagewise pattern, the first coating weight differing from the second coating weight.

17. The method of claim 13, wherein the primer coating is not present under a portion of the imagewise pattern.

18. The method of claim 12, wherein the primer coating has a first coating weight under a first portion of the imagewise pattern and a second coating weight under a second portion of the imagewise pattern, the first coating weight differing from the second coating weight.

19. The method of claim 6, wherein the print substrate is uncoated prior to depositing the primer composition.

20. The method of claim 6, wherein the print substrate comprises a material selected from the group consisting of cardboard, brown paper, kraft paper, plastic, vinyl, and any combination thereof.
